(19) United States
(12) Patent Application Publication
(10) Pub. No.: US 2026/0301400 A1
(43) Pub. Date: Oct. 1, 2026

(54) FEDERATED LEARNING SYSTEM AND METHOD

(71) Applicant: Sony Group Corporation, Tokyo (JP)

(72) Inventors: Jingtao LI, Tempe, AZ (US); Weiming ZHUANG, Singapore (SG); Chen CHEN, Schlieren (CH); Lingjuan LYU, Schlieren (CH); Haolin YUAN, Towson, MD (US)

(73) Assignee: Sony Group Corporation, Tokyo (JP)

(21) Appl. No.: 19/096,021

(22) Filed: Mar. 31, 2025

(51) Int. Cl. G06V 10/94; G06V 10/774

(52) U.S. Cl. CPC G06V 10/95; G06V 10/774

(57) ABSTRACT

A system for managing an iterative federated learning process, comprising circuitry configured to distribute a first decoder to each of a plurality of client devices, each of the client devices is configured to perform a respective training process for the first decoder to generate a corresponding trained decoder, receive a plurality of trained decoders, each being received from a respective one of the plurality of client devices, and perform, responsive to a first condition defining an aggregation rate, a decoder exchange process or a decoder aggregation process using the plurality of trained decoders, wherein in response, distribute a respective one of the plurality of trained decoders to each client device, the respective one being different to the trained decoder, and in response to the decoder aggregation, distribute an aggregate decoder generated by that process to each of the plurality of client devices.

### BACKGROUND OF THE INVENTION

### Field of the Invention

This disclosure relates to a federated learning system and method.

### Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Object detection is a computer vision task in which one or more objects are able to be detected within captured images. This is useful for a number of different tasks in which it is desirable to be able to characterise the content of an image—such as surveillance, image description, and event detection. Object detection is distinct from image classification as a task, in that classification assigns labels to an image based upon recognised features—while object detection locates specific features within an image. Such distinctions contribute to object detection being a more complex process which offers unique challenges amongst computer vision tasks.

Training an efficient and effective object detection model can be challenging, due to the demands of the object detection process. For instance, object detection may require processing intricate spatial information and handling objects of varying scales—with these varying significantly for different applications. Training may also be challenging due to limitations upon the generation of effective training datasets; precise labelling of objects within images in a training dataset means that generating the datasets can be particularly burdensome (especially with large training datasets). As a result, there is often only a limited amount of training data available-which can lead to poor-quality object detection, particularly in scenarios or environments for which training datasets are not readily available.

It is therefore apparent that training an effective object detection model in an efficient manner can be a difficult task, particularly if it is desired that the model is a generalised one that is effective across a diverse range of environments and/or scenarios. Such difficulties may become even more apparent when the model is to be implemented using devices having limited processing capabilities.

It is in the context of the above discussion that the present disclosure arises.

### SUMMARY OF THE INVENTION

This disclosure is defined by claim 1. Further respective aspects and features of the disclosure are defined in the appended claims.

It is to be understood that both the foregoing general description of the invention and the following detailed description are exemplary, but are not restrictive, of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an exemplary server hardware;

FIG. 2 schematically illustrates a federated learning process;

FIG. 3 schematically illustrates a federated learning method;

FIG. 4 schematically illustrates a cluster shuffle/exchange scheme;

FIG. 5 schematically illustrates a system for managing federated learning; and

FIG. 6 schematically illustrates a method for managing federated learning.

### DESCRIPTION OF THE EMBODIMENTS

Referring now to the drawings, wherein like reference numerals designate identical or corresponding parts throughout the several views, embodiments of the present disclosure are described.

FIG. 1 schematically illustrates exemplary server hardware; this Figure is not intended to be limiting, but instead shows an example hardware arrangement that may be used to implement a method according to the present disclosure. Any alternative arrangement of hardware may be used to implement the server, and alternative processing devices (such as TPUs) may be utilised as appropriate.

The server device 10 comprises a central processing unit (CPU) 20 and a graphics processing unit (GPU) 30, each of which is configured to communicate with the random access memory (RAM) 40. These units provide a processing functionality, which can be used to execute the server methods described below.

These units are configured to communicate with a solid state drive (SSD) 50 and/or hard disk drive (HDD) 70 via a bus 100 (or any other suitable connection). Data is received from other devices (such as client devices in communication with the server 10) via a data port 60; the data port 60 may be an Ethernet® port, for example, or any other wired or wireless data connection.

Embodiments of the present disclosure provide an efficient federated learning system and method for object detection, which offers enhanced privacy, scalability, and effective cross-domain learning. This also results in a more effective object detection being achieved by the devices which implement the trained object detection model, in addition to the advantages inherent in the proposed training process.

Existing federated learning processes are typically used to train a generalised model across diverse domain datasets. In federated learning, multiple entities (clients) collaborate to conduct training, usually under the coordination of a server. Such learning generally comprises four steps that are performed iteratively until a stopping condition (such as convergence or high test accuracy) is met. These steps include:
1. The server sends a global model to the selected clients;
2. Clients conduct local training on their local data;
3. Clients upload the training updates of the model to the server; and
4. The server aggregates the training updates to obtain a new global model.

While this can be an effective method of training, a high level of performance of the final trained model is not always achieved. This is because training data at each of the client devices is typically different-which can mean that the aggregation of the training updates may not be effective due to significant differences in the training updates of the model from each client.

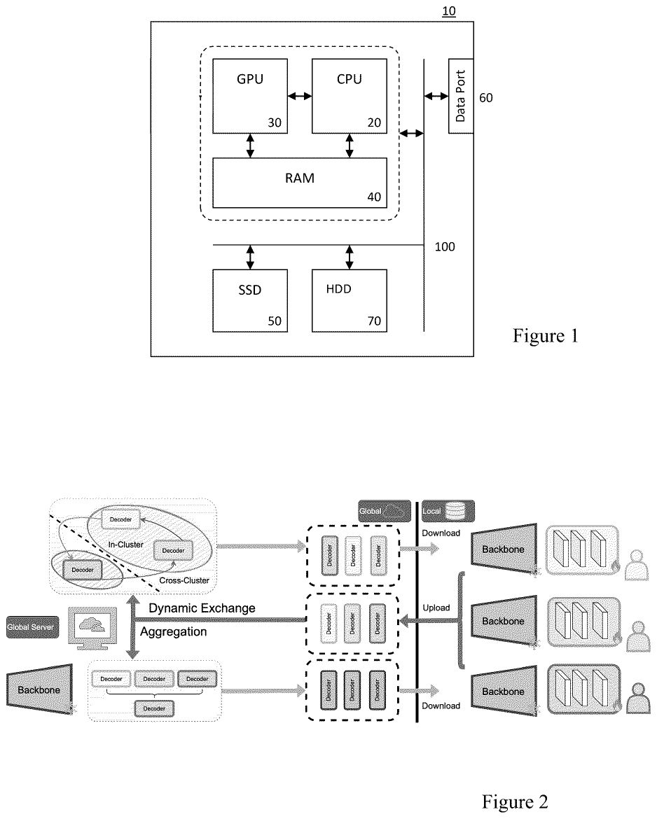

FIG. 2 schematically illustrates a federated learning process in accordance with implementations of the present disclosure. This method aims to simulate multiple centralised learning processes concurrently, whilst also not requiring client devices to share their local data—this therefore maintains client privacy, whilst also taking advantage of the fact that centralised learning typically outperforms traditional federated learning under cross-domain data distributions.

The process is implemented by a global server and a plurality of local devices; these local devices may be any devices which are configured to perform an object detection process. For instance, the local devices may comprise one or more cameras with associated processing hardware. These may be able to communicate with the server directly via an internet connection, in some implementations. The local devices may be all operated by a single organisation (such as a business), with the training being performed by that organisation, or the devices may be more widespread such that a more generalised model can be obtained by the training process.

The local devices may be provided for different purposes (such as detecting different objects) and/or different use cases (such as detecting the same objects, but under different conditions and/or for different reasons). For instance, two local devices may be configured to detect vehicles-one for traffic monitoring, and one as a part of a self-driving car. These will offer unique training datasets, due to different camera angles, camera motion, the effect of weather, and a number of other conditions.

To initiate the process, a backbone and a plurality of decoders are defined; the backbone is a fixed part of the model, whilst the decoder is a dynamic part of the model which is trained to recognise objects in particular scenarios.

The backbone may be a vision foundation model (VFM) trained on general recognition tasks, and typically extracts features from input data (e.g. edges, shapes, etc. from an image) and outputs a feature representation or token; the decoders then receives the features/tokens and generate predictions/output data thereby provide a more effective task-specific recognition process (once trained to provide their task specific predictions from the output features/tokens of the backbone). The approach of using a backbone can reduce the processing demands on the local devices, particularly in relation to visual abstraction but more generally to any input data abstraction provided by the backbone. Typically the backbone has been pre-trained to output its representations, and is now fixed/frozen, with task specific functionality coming from the respective decoders. However, optionally the backbone can be trained further although this will increase the computational burden of the scheme. The plurality of decoders may initially be identical, with the same decoder being transmitted to each local device, or they may have different initial parameters as desired for a given implementation.

Once received, the local devices each perform a training process using local data-such as images captured by a camera integrated with the local device, or a locally-stored training dataset that has been generated for training a model to perform the intended function of the local device. For instance, a local device that is intended to perform traffic monitoring may capture images of traffic to use as training data, or may otherwise have access to a training dataset which comprises images of traffic. The training process is performed to update parameters of the decoders (the backbone remains fixed). Meanwhile if the local devices do not have local data available, optionally task-relevant training data could be provided via the global server or by a 3^{rd} party.

Once each of the local devices has performed a training process, the decoders are uploaded to the global server. The server is then configured to perform either a global aggregation process or a dynamic exchange process; the selection may be dependent upon a number of rounds of training processes that have been performed. Typically, the exchange process is performed more frequently than the aggregation process, with the aggregation being performed every nth round (with n being an integer greater than one) and the exchange being performed otherwise. The aggregation process may be any process by which the updates to the respective decoders are combined, such as for example an averaging operation or a weighted averaging operation.

This process is performed in an iterative manner until a termination condition is met; this may be a predetermined number of training rounds, for instance, or the model performance may be evaluated against test data at particular intervals to determine whether a predetermined level of performance has been obtained.

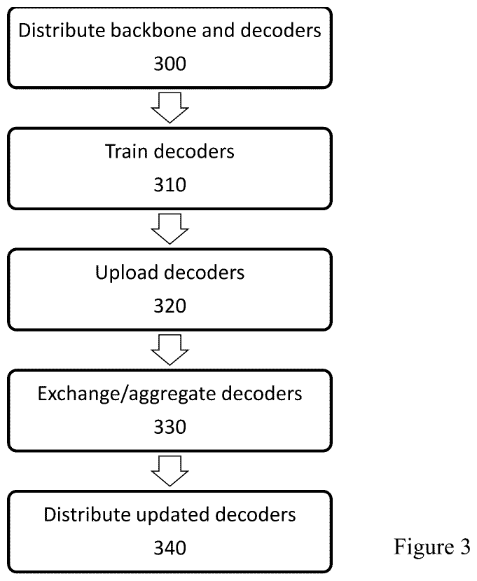

FIG. 3 schematically illustrates a method which corresponds to the process of FIG. 2.

At a step 300, distribution of the backbone and initial decoder to each of a plurality of local devices via a network is performed by the server. In some cases, the backbone may be pre-stored at one or more of the local devices (for instance, loaded during manufacture or obtained at an earlier time), precluding the need to distribute the backbone over a network.

At a step 310, each of the local devices performs a training process on the received decoder. This training process is based upon locally stored or obtainable data, such that the training dataset is typically partially or wholly different for each of the local devices. The training dataset is intended to be specific to a particular purpose for which the local device is intended, meaning that each instance of the decoder is subject to a different training process.

At a step 320, the trained decoders are uploaded to the server by the respective local devices. This step is performed in response to the training process of step 310 being completed, which can be determined based upon a predetermined time having elapsed, a number of samples of the training data being processed, or any other condition.

At a step 330, a condition is evaluated to determine whether an exchange or aggregation process is performed; this is typically responsive to the number of training iterations that have been implemented. In the case that an exchange process is performed, a different one of the uploaded decoders to that which was uploaded by that local device is identified for each of the local devices, as described in more detail elsewhere herein.

Alternatively, if an aggregation process is performed then a new general decoder is generated based upon the uploaded decoders using any preferred aggregation process, as noted previously.

At a step 340, decoders are distributed to each of the local devices-either the respective identified decoders (in response to an exchange process) or the new general decoder (in response to an aggregation process).

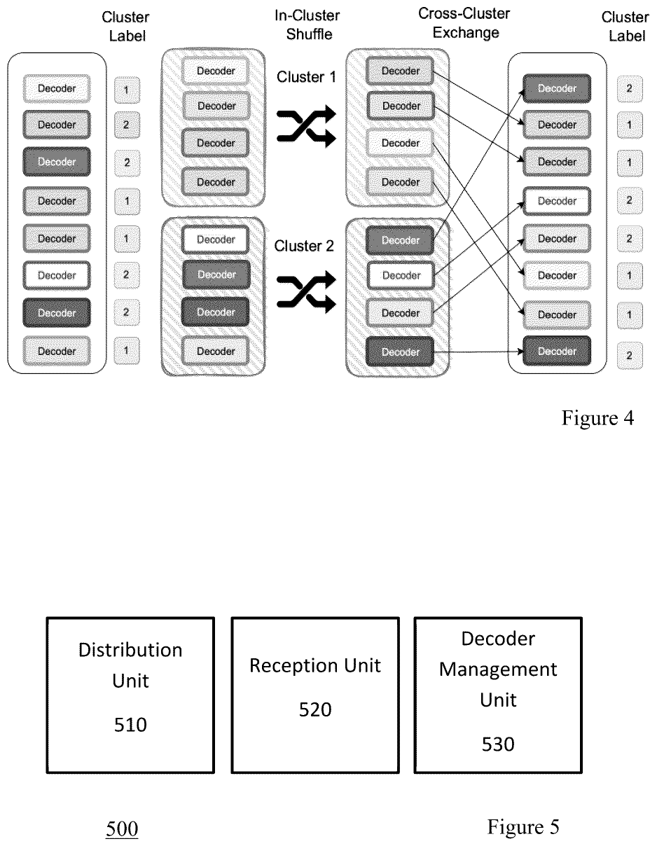

The exchange process may be any process in which uploaded decoders are assigned to a new local device, such that the uploaded decoders can be subjected to a different training process to that which was used to generate the uploaded decoder. An example of such a process is described with reference to FIG. 4, but the present disclosure should not be regarded as limiting in this regard. This exemplary exchange process comprises two steps, a clustering step and a model exchange step.

The clustering step is performed to generate two clusters of decoders, each of which typically but not necessarily has the same number of decoders in that cluster. To initiate this step, each of the decoders is considered an independent cluster; these clusters are then iteratively merged until only two clusters remain. While two clusters may be preferable, the number of clusters may be determined freely. The merging of clusters is performed on the basis of a linkage distance, such that two clusters having the smallest linkage distance are merged at each iterative stage.

Any preferred measure of the linkage distance between clusters may be used. For instance, the distance may be calculated using an average linkage approach, in line with the equation:

$${d}_{AL} ( {C}_{i} , {C}_{j} ) = \frac{1}{\vert {C}_{i} \vert \vert {C}_{j} \vert} {\sum }_{{g}_{u} ∈ {C}_{i}} {\sum }_{{g}_{v} ∈ {C}_{j}} {d}_{C} ( {g}_{u} , {g}_{v} )$$

Where Cᵢ and Cⱼ respectively denote two clusters i and j, whilst gᵤ and gᵥ are model parameter matrices of decoders u and v (which are decoders that are respectively part of clusters i and j). The model parameter matrices are representative of a set of variables or weights associated with the decoder, and thereby are useful for characterising the decoder itself. The parameter d_{C} is a cosine distance measure given by:

$${d}_{C} ( {g}_{i} , {g}_{j} ) = 1 - \frac{{g}_{i} \cdot {g}_{j}}{‖ {g}_{i} ‖ ‖ {g}_{j} ‖}$$

It will be appreciated that other clustering approaches may be considered that are likewise based on the similarity of clients' decoder parameters.

In any event, once the two (or more) clusters have been determined, processing proceeds to the exchange step. The exchange step may be performed in a manner that seeks to match a decoder with a local device which operates in a different data domain (such as being configured to perform an unrelated task). This is able to be implemented by ensuring that a local device is provided with a decoder which belongs to a different cluster to the decoder that it uploaded in the most recent upload step—the different clusters are considered to comprise decoders trained in different domains. This is referred to as a cross-cluster exchange.

Alternatively, or in addition, an in-cluster exchange may be performed in which the decoders within a cluster are randomly shuffled or otherwise reordered. In-cluster exchanges may be useful in that it enables models in the same cluster to be trained in similar domains, thereby building upon the training already performed. In the case that both an in-cluster and cross-cluster exchange is performed, as shown in the example of FIG. 4, the exchanges are considered complementary in that it reduces the frequency with which a given decoder would be sent to the same local device between aggregation rounds.

Notably if two clusters are a different size, then having only the cross-cluster exchange will result in some decoders not being exchanged. Consequently the in-cluster shuffle would ensure that these additional decoders are also exchanged with other decoders, albeit within the same cluster.

It will be appreciated that the above clustering scheme could be extended to three or more clusters Cᵢ, Cⱼ, Cₖ, etc., but with each additional cluster used, the difference or gap between respective clusters will become smaller, and so the effective difference in domain between reallocated decoder and client may be reduced.

FIG. 5 schematically illustrates a system 500 for managing an iterative federated learning process, the system comprising a distribution unit 510, a reception unit 520, and a decoder management unit 530. Here, the term ‘iterative’ means that multiple rounds of the distribution, training, receiving, exchange/aggregation processes are performed by the system. In this manner, the decoders are trained for an effective object detection function—with the end result expected to be a single aggregated decoder which is effective at performing object detection in a variety of domains in the case that the federated learning process is used to train an object detection model.

The system 500 may be implemented by a server, utilising any preferred arrangement of processing hardware (such as CPUs and GPUs, as exemplified by FIG. 1) with communication being performed via one or more network communication components. The system 500 is configured to communicate with a plurality of client devices, wherein the plurality of client devices may comprise client devices configured to perform object detection tasks in different domains (such as detecting different objects and/or under different implementation conditions).

The distribution unit 510 is configured to distribute at least a first decoder to each of the plurality of client devices, wherein each of the client devices is configured to perform a respective training process for the or each first decoder to generate a corresponding trained decoder. The training process may comprise any suitable approach, with the aim of improving the object detection functionality of the decoder based upon local training data. Whilst typically a client device may only train one decoder, it may optionally train more, for example if it implements more than one type of object detection functionality.

The distribution unit 510 may be further configured to distribute a backbone model to each of the client devices, wherein the backbone is a vision foundation model to be used in conjunction with the first decoder to perform an object detection process. The distribution of the backbone model may not be required however, as it may already be stored at the client device due to an earlier distribution or as a part of a manufacture process (for instance).

The reception unit 520 is configured to receive a plurality of trained decoders, each being received from a respective one of the plurality of client devices. In other words, each of the client devices transmits their respective updated version of the decoder or decoders transmitted to them by the distribution unit 510 to the system 500.

The decoder management unit 530 is configured to perform, responsive to a first condition defining an aggregation rate, a decoder exchange process or a decoder aggregation process using the plurality of trained decoders. The first condition may be dependent upon a number of iterations of the learning process that have occurred, for example, with the aggregation process being performed every nth iteration (n being an integer greater than one). This means that the decoder exchange process is performed x times for each time that the decoder aggregation process is performed, x being an integer greater than 1. Optionally n may be made a function of the number of decoders, the number of decoders in a shuffled set, and/or the number of clients, so that n is responsive to the number of times a given decoder is provided to a different client before aggregation of the decoders occurs.

The decoder aggregation process may be any preferred process in which a single decoder is generated based upon a plurality of input decoders, the single decoder being representative of the plurality of input decoders. As noted previously, non-exhaustive examples include averaging, and weighted averaging. Weighted averaging may be based for example on relative distance/difference between decoder parameters, as per the clustering algorithm above, so as to reduce the influence of any decoder that is an outlier after n−1 exchanges have occurred.

The decoder exchange process may be any process which causes each of the client devices to receive a different decoder to that which was transmitted to the reception unit 520 by that client device in the previous step of the process. An example of this is discussed with reference to FIG. 4, with this example not being considered limiting upon the present disclosure.

In accordance with the example discussed with reference to FIG. 4, the decoder exchange process may comprise a clustering process which generates two clusters of decoders in dependence upon their similarity; the two clusters may be generated by iteratively merging clusters having a smallest linkage distance (for instance, determined in accordance with an average linkage formula), with each of the decoders initially being treated as an independent cluster. Alternatively, a grouping may be performed in a non-iterative manner as preferred. Once the clusters have been generated, the distribution unit 510 is configured to distribute a respective one of the plurality of trained decoders to a client device which belongs to a different cluster to the trained decoder which was received from that client device. The decoder exchange process may also comprise a reordering (for one or both clusters) of the decoders within a generated cluster.

In this manner, the decoder management unit 530 is configured to perform an exchange or aggregation process utilising the received decoders from each of the client devices. The decoder management unit 530 may also be configured to monitor a termination condition for the iterative federated learning process; the termination condition may comprise a number of iterations of the federated learning process, a convergence of the received trained decoders, and/or an average precision measure AP or mean average precision measure mAP converging and not improving, or improving at a rate below a termination threshold, for example. Typically the termination condition is evaluated after an aggregation step, based on the new global/single decoder. The final decoder manipulation process performed by the decoder management unit 530 should be an aggregation rather than an exchange, so as to generate a single decoder as an output of the federated learning process.

The distribution unit 510 is then configured to distribute the results of the processing performed by the decoder management unit 530. More specifically, the distribution unit 510 is configured, in response to the decoder exchange process being performed, to distribute a respective one of the plurality of trained decoders to each client device, the respective one being different to the trained decoder received from that client device. The distribution unit 510 is also configured, in response to the decoder aggregation process being performed, to distribute an aggregate decoder generated by that process to each of the plurality of client devices. The decoders distributed at this stage of the process are then used for the next iteration of the training and management process—in other words, the decoders distributed here take the place of the first decoders.

The arrangement of FIG. 5 is an example of a processor or similar circuitry (for example, a GPU, TPU, and/or CPU located in a games console or any other computing device) that is operable to manage an iterative federated learning process, and in particular is operable to:

distribute a first decoder to each of a plurality of client devices, wherein each of the client devices is configured to perform a respective training process for the first decoder to generate a corresponding trained decoder;
receive a plurality of trained decoders, each being received from a respective one of the plurality of client devices;
perform, responsive to a first condition defining an aggregation rate, a decoder exchange process or a decoder aggregation process using the plurality of trained decoders; and
distribute, in response to the decoder exchange process being performed, to distribute a respective one of the plurality of trained decoders to each client device, the respective one being different to the trained decoder received from that client device, or
distribute, in response to the decoder aggregation process being performed, to distribute an aggregate decoder generated by that process to each of the plurality of client devices.

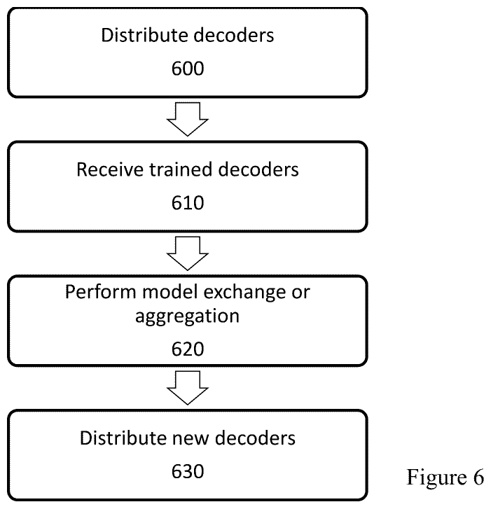

The method of FIG. 6 schematically illustrates a method for managing an iterative federated learning process. This method may be performed by the system of claim 5, and in accordance with the discussion with reference to the process of FIG. 2.

A step 600 comprises distributing a first decoder to each of a plurality of client devices, wherein each of the client devices is configured to perform a respective training process for the first decoder to generate a corresponding trained decoder.

A step 610 comprises receiving a plurality of trained decoders, each being received from a respective one of the plurality of client devices.

A step 620 comprises performing, responsive to a first condition defining an aggregation rate, a decoder exchange process or a decoder aggregation process using the plurality of trained decoders.

A step 630 comprises distributing new encoders; that is, outputting encoders in accordance with the processing of step 620. In particular, this includes distributing, in response to the decoder exchange process being performed, a respective one of the plurality of trained decoders to each client device, the respective one being different to the trained decoder received from that client device. Alternatively, in response to the decoder aggregation process being performed, the step 630 comprises an aggregate decoder generated by that process to each of the plurality of client devices.

Referring again to FIG. 1, this is also a non-limiting example of a similar device operating as a client, for example as a so-called edge or internet of things client performing a specific task.

Consequently, in embodiments of the present description, a client device comprises circuitry configure to store a backbone model and a current decoder (e.g. the first decoder or a subsequent exchanged decoder), as described elsewhere herein; an interface to periodically make the current decoder available to a server via a client interface (e.g. to upload to the server), as described elsewhere herein; the circuitry being configured to receive subsequent decoders from the server to each store as the current decoder; a subsequent decoder being one of a decoder received via the server from another client device (e.g. shuffled/exchanged as described elsewhere herein), and a decoder that is an aggregation of a number of decoders from other devices aggregated by the server, as described elsewhere herein; wherein the circuitry is configured to update a stored decoder responsive to a specific function associated with the client (e.g. to train the current decoder before returning it to the server).

In principle the client does not need to distinguish between first and subsequent decoders, or whether these are exchanged or aggregated decoders; but in the event that training conditions are varied for aggregated decoders (e.g. having a different learning rate or a particular training regimen), then the client could distinguish either based on a count of the received decoders (the nth being an aggregate) or optionally based on indicative metadata included with the received decoders.

It will be appreciated that whilst the above systems and methods have been described in relation to vision processing tasks such as object recognition based on image data, the principles herein and not so limited and may be applied to any form of input data for which a consistent abstraction may be derived by a backbone, and for which a generalised decoder can be trained for two or more respective tasks using the systems and techniques herein. An example may be for audio signals and respective analyses for speech recognition, voice identification, and pitch tracking.

The techniques described above may be implemented in hardware, software or combinations of the two. In the case that a software-controlled data processing apparatus is employed to implement one or more features of the embodiments, it will be appreciated that such software, and a storage or transmission medium such as a non-transitory machine-readable storage medium by which such software is provided, are also considered as embodiments of the disclosure.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

Embodiments of the present disclosure may be implemented in accordance with any one or more of the following numbered clauses:

Clause 1. A system for managing an iterative federated learning process, the system comprising:
a distribution unit configured to distribute a first decoder to each of a plurality of client devices, wherein each of the client devices is configured to perform a respective training process for the first decoder to generate a corresponding trained decoder;
a reception unit configured to receive a plurality of trained decoders, each being received from a respective one of the plurality of client devices; and
a decoder management unit configured to perform, responsive to a first condition defining an aggregation rate, a decoder exchange process or a decoder aggregation process using the plurality of trained decoders, wherein:
the distribution unit is configured, in response to the decoder exchange process being performed, to distribute a respective one of the plurality of trained decoders to each client device, the respective one being different to the trained decoder received from that client device, and
the distribution unit is configured, in response to the decoder aggregation process being performed, to distribute an aggregate decoder generated by that process to each of the plurality of client devices.

Clause 2. A system according to clause 1, wherein the distribution unit is further configured to distribute a backbone model to each of the client devices, wherein the backbone is a vision foundation model to be used in conjunction with the first decoder.

Clause 3. A system according to any preceding clause, wherein the plurality of client devices comprises client devices configured to perform object detection tasks in different domains.

Clause 4. A system according to any preceding clause, wherein the first condition is dependent upon a number of iterations of the learning process that have occurred.

Clause 5. A system according to any preceding clause, wherein the decoder exchange process is performed x times for each time that the decoder aggregation process is performed, x being an integer greater than 1.

Clause 6. A system according to any preceding clause, wherein the decoder exchange process comprises a clustering process which generates two clusters of decoders in dependence upon their similarity.

Clause 7. A system according to clause 6, wherein the two clusters are generated by iteratively merging clusters having a smallest linkage distance, and wherein each of the decoders is initially treated as an independent cluster.

Clause 8. A system according to clause 7, wherein the linkage distance is calculated using an average linkage formula.

Clause 9. A system according to any of clauses 6-8, wherein the distribution unit is configured to distribute a respective one of the plurality of trained decoders to a client device which belongs to a different cluster to the trained decoder which was received from that client device.

Clause 10. A system according to any of clauses 6-9, wherein the decoder exchange process comprises a reordering of the decoders within a generated cluster.

Clause 11. A system according to any preceding clause, wherein the federated learning process is used to train an object detection model.

Clause 12. A system according to any preceding clause, wherein the decoder management unit is configured to monitor a termination condition for the iterative federated learning process.

Clause 13. A system according to clause 12, wherein the termination condition comprises a number of iterations of the federated learning process and/or a convergence of the received trained decoders.

Clause 14. A method for managing an iterative federated learning process, the method comprising:
distributing a first decoder to each of a plurality of client devices, wherein each of the client devices is configured to perform a respective training process for the first decoder to generate a corresponding trained decoder;
receiving a plurality of trained decoders, each being received from a respective one of the plurality of client devices;
performing, responsive to a first condition defining an aggregation rate, a decoder exchange process or a decoder aggregation process using the plurality of trained decoders; and
distributing, in response to the decoder exchange process being performed, a respective one of the plurality of trained decoders to each client device, the respective one being different to the trained decoder received from that client device, or
distributing, in response to the decoder aggregation process being performed, an aggregate decoder generated by that process to each of the plurality of client devices.

Clause 15. A non-transitory, computer readable storage medium containing a computer program comprising computer executable instructions that when executed by a computer system, cause the computer system to perform a method for managing an iterative federated learning process, the method comprising:
distributing a first decoder to each of a plurality of client devices, wherein each of the client devices is configured to perform a respective training process for the first decoder to generate a corresponding trained decoder;
receiving a plurality of trained decoders, each being received from a respective one of the plurality of client devices;
performing, responsive to a first condition defining an aggregation rate, a decoder exchange process or a decoder aggregation process using the plurality of trained decoders; and
distributing, in response to the decoder exchange process being performed, a respective one of the plurality of trained decoders to each client device, the respective one being different to the trained decoder received from that client device, or
distributing, in response to the decoder aggregation process being performed, an aggregate decoder generated by that process to each of the plurality of client devices.

1. A system for managing an iterative federated learning process, the system comprising:
distribution circuitry configured to distribute a first decoder to each of a plurality of client devices, wherein each of the client devices is configured to perform a respective training process for the first decoder to generate a corresponding trained decoder;
reception circuitry configured to receive a plurality of trained decoders, each being received from a respective one of the plurality of client devices; and
decoder management circuitry configured to perform, responsive to a first condition defining an aggregation rate, a decoder exchange process or a decoder aggregation process using the plurality of trained decoders, wherein:
the distribution circuitry is configured, in response to the decoder exchange process being performed, to distribute a respective one of the plurality of trained decoders to each client device, the respective one being different to the trained decoder received from that client device, and
the distribution circuitry is configured, in response to the decoder aggregation process being performed, to distribute an aggregate decoder generated by that process to each of the plurality of client devices.

2. The system of claim 1, wherein the distribution circuitry is further configured to distribute a backbone model to each of the client devices, wherein the backbone is a vision foundation model to be used in conjunction with the first decoder.

3. The system of claim 1, wherein the plurality of client devices comprises client devices configured to perform object detection tasks in different domains.

4. The system of claim 1, wherein the first condition is dependent upon a number of iterations of the learning process that have occurred.

5. The system of claim 1, wherein the decoder exchange process is performed x times for each time that the decoder aggregation process is performed, x being an integer greater than 1.

6. The system of claim 1, wherein the decoder exchange process comprises a clustering process which generates two clusters of decoders in dependence upon their similarity.

7. The system of claim 6, wherein the two clusters are generated by iteratively merging clusters having a smallest linkage distance, and wherein each of the decoders is initially treated as an independent cluster.

8. The system of claim 7, wherein the linkage distance is calculated using an average linkage formula.

9. A system according to claim 6, wherein the distribution circuitry is configured to distribute a respective one of the plurality of trained decoders to a client device which belongs to a different cluster to the trained decoder which was received from that client device.

10. A system according to claim 6, wherein the decoder exchange process comprises a reordering of the decoders within a generated cluster.

11. The system of claim 1, wherein the federated learning process is used to train an object detection model.

12. The system of claim 1, wherein the decoder management circuitry is configured to monitor a termination condition for the iterative federated learning process.

13. The system of claim 12, wherein the termination condition comprises a number of iterations of the federated learning process and/or a convergence of the received trained decoders.

14. A method for managing an iterative federated learning process, the method comprising:
distributing a first decoder to each of a plurality of client devices, wherein each of the client devices is configured to perform a respective training process for the first decoder to generate a corresponding trained decoder;
receiving a plurality of trained decoders, each being received from a respective one of the plurality of client devices;
performing, responsive to a first condition defining an aggregation rate, a decoder exchange process or a decoder aggregation process using the plurality of trained decoders; and
distributing, in response to the decoder exchange process being performed, a respective one of the plurality of trained decoders to each client device, the respective one being different to the trained decoder received from that client device, or
distributing, in response to the decoder aggregation process being performed, an aggregate decoder generated by that process to each of the plurality of client devices.

15. A non-transitory, computer readable storage medium containing a computer program comprising computer executable instructions that when executed by a computer system, cause the computer system to perform a method for managing an iterative federated learning process, the method comprising:
distributing a first decoder to each of a plurality of client devices, wherein each of the client devices is configured to perform a respective training process for the first decoder to generate a corresponding trained decoder;
receiving a plurality of trained decoders, each being received from a respective one of the plurality of client devices;
performing, responsive to a first condition defining an aggregation rate, a decoder exchange process or a decoder aggregation process using the plurality of trained decoders; and
distributing, in response to the decoder exchange process being performed, a respective one of the plurality of trained decoders to each client device, the respective one being different to the trained decoder received from that client device, or
distributing, in response to the decoder aggregation process being performed, an aggregate decoder generated by that process to each of the plurality of client devices.

16. A client device comprising:
circuitry configure to store a backbone model and a current decoder;
an interface to periodically make the current decoder available to a server via a client interface
the circuitry being configured to receive subsequent decoders from the server to each store as the current decoder;
a subsequent decoder being one of a decoder received via the server from another client device,
and a decoder that is an aggregation of a number of decoders from other devices aggregated by the server; wherein
the circuitry is configured to update a stored decoder responsive to a specific function associated with the client.
